(19) United States
(12) Patent Application Publication
(10) Pub. No.: US 2015/0067576 A1
(43) Pub. Date: Mar. 5, 2015

(54) DISPLAY DEVICE, IMAGE FORMING APPARATUS, AND DISPLAY CONTROL METHOD

(71) Applicant: KYOCERA Document Solutions Inc., Osaka (JP)

(72) Inventor: Takuya TSUJI, Osaka (JP)

(73) Assignee: KYOCERA Document Solutions Inc., Osaka (JP)

(21) Appl. No.: 14/467,595

(22) Filed: Aug. 25, 2014

(30) Foreign Application Priority Data
Aug. 29, 2013 (JP) 2013-177897

(51) Int. Cl. G06F 3/0483; G06F 3/0488

(52) U.S. Cl. CPC G06F 3/0483; G06F 3/0488; G06F 3/04883
USPC 715/776

(57) ABSTRACT

The display device includes a display section having a display surface, a touch panel, and a display control section. The display section is configured to display a plurality of pages. The touch panel is configured to detect a touch point in touch with the display surface of the display section. The display control section is configured to flip a page toward a last page or a top page of the pages in a direction corresponding to the travel direction of the touch point that the touch panel detects. The display control section changes an amount of page flip each time the touch panel detects a change in the travel direction.

### INCORPORATION BY REFERENCE

The present application claims priority under 35 U.S.C. §119 to Japanese Patent Application No. 2013-177897, filed Aug. 29, 2013. The contents of this application are incorporated herein by reference in their entirety.

### BACKGROUND

The present disclosure relates to display devices, image forming apparatuses, and display control methods for display of a plurality of pages.

Portable terminals of some type are configured such that when a touch panel displaying a single image file (page) detects a flick by user's single finger, an image file moved by one file from the currently displayed image file is displayed. Likewise, when the touch panel detects a flick by user's three fingers, an image file moved by three files from to the currently displayed image file is displayed.

### SUMMARY

A display device according to one aspect of the present disclosure includes a display section, a detection section, and a display control section. The display section has a display surface and is configured to display a plurality of pages. The detecting section is configured to detect a touch point in touch with the display surface of the display section. The display control section is configured to flip a page toward a last page or a top page of the pages in a direction corresponding to a travel direction of touch point. The display control section changes an amount of page flip each time the detecting section detects a change in the travel direction.

An image forming apparatus according to the second aspect of the present disclosure includes a display device according to the first aspect of the present disclosure and an image forming section. The image forming section is configured to form on a sheet an image of a page selected from the pages.

A display control method according to the third aspect of the present disclosure includes: displaying a plurality of pages on a display section; obtaining information on a touch point in touch with a display surface of the display section; flipping a page toward a last page or a top page of the pages in a direction corresponding to a travel direction of the touch point; and changing an amount of page flip each time a change in the travel direction of the touch point is detected.

### BRIEF DESCRIPTION OF THE DRAWINGS

FIG. 1 is a block diagram showing a display device according to the first embodiment of the present embodiment.

FIGS. 2A-2C are diagrams for explaining page flip control that the display device performs according to the first embodiment of the present disclosure.

FIG. 3 is a flowchart depicting a display control method that the display device performs according to the first embodiment of the present disclosure.

FIG. 4 is a diagram for explaining a page display format in which the display device initially displays a plurality of pages according to the second embodiment of the present disclosure.

FIGS. 5A-5D are diagrams for explaining page flip control that the display device performs according to the second embodiment of the present disclosure.

FIG. 6 is a flowchart depicting a display control method that the display device performs according to the second embodiment of the present disclosure.

FIGS. 7A-7D are diagrams for explaining page flip control that the display device performs according to the third embodiment of the present disclosure.

FIG. 8 is a flowchart depicting a display control method that the display device performs according to the third embodiment of the present disclosure.

FIG. 9 is a block diagram showing an image forming apparatus according to the fourth embodiment of the present embodiment.

FIG. 10 is a schematic cross sectional view explaining the image forming apparatus according to the fourth embodiment of the present disclosure.

### DETAILED DESCRIPTION

Embodiments of the present disclosure will be described below with reference to the accompanying drawings. Like numerals denote like elements or corresponding elements in the drawings, and duplicate description shall be omitted.

### First Embodiment

[Basic Principle]

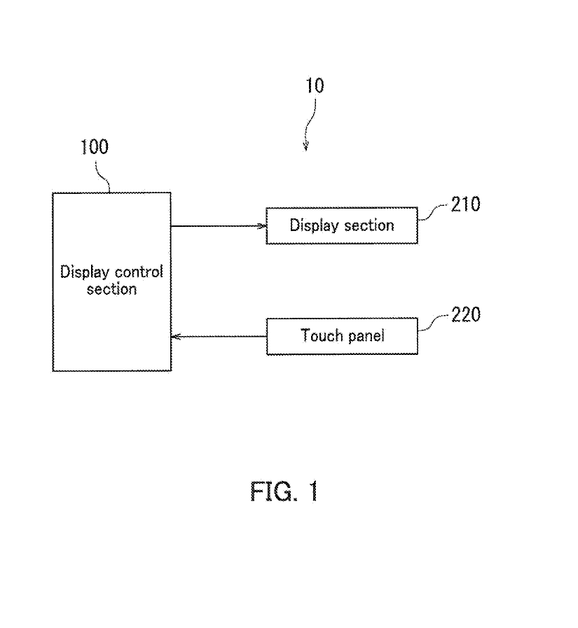

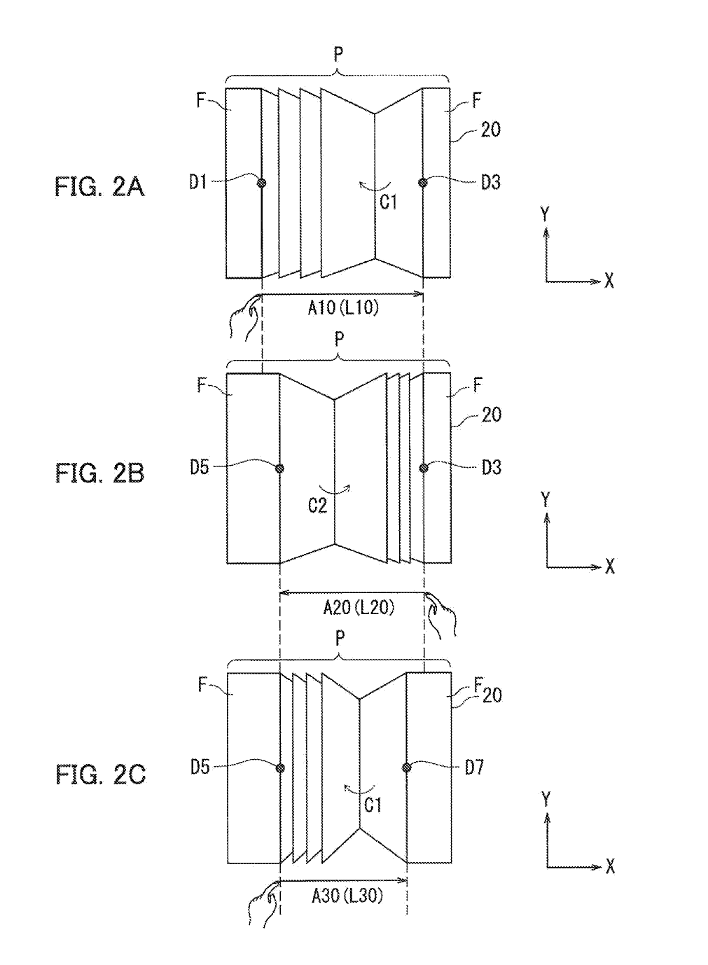

With reference to FIGS. 1 and 2, description will be made about the basic principle of a display device 10 according to the first embodiment of the present disclosure. FIG. 1 is a block diagram showing the display device 10. FIGS. 2A-2C are diagrams for explaining page flip control that the display device 10 performs. The display device 10 includes a display control section 100, a display section 210, and a touch panel 220 as a detection section.

The display section 210 has a display surface and displays a plurality of pages P of, for example, an eBook or a set of images. The touch panel 220 detects a touch point in touch with the display surface of the display section 210. When the touch panel 220 detects a touch point moving in a travel direction (e.g., a travel direction from a point D1 to a point D3), the display control section 100 flips the pages P toward the last page or the top page of the pages P (see an arrow C1 in FIG. 2A, for example) in a direction corresponding to the travel direction. The display control section 100 changes the amount of page flip each time the touch panel 220 detects a change in the travel direction of the touch point. For example, the travel direction of the touch point is reversed at the point D3, a point D5, and then a point D7, the amount of page flip is changed from an amount of flip A10 to an amount of flip A20 and then to an amount of flip A30.

According to the first embodiment, each time the touch panel 220 detects a change in the travel direction of the touch point, the amount of page flip can be decreased in a stepwise manner by changing the amount of page flip (e.g., the amounts of page flip: A10>A20>A30). As a result, a page search range can be reduced, thereby mitigating a burden in page search for a target page P from the pages P.

[Details of Page Flip Control]

Page flip control will be described in detail with reference to FIGS. 1 and 2. An eBook 20 will be discussed as an example in the first embodiment. The X axis and Y axis are in parallel to the long side and the short side of the display surface of the display section 210, respectively. The display control section 100 calculates an amount of travel of the touch point on the basis of the position of the touch point that the touch panel 220 detects. The amount of travel of the touch point in the present specification means an X component of a movement vector of the touch point.

The display control section 100 causes the display section 210 to display the eBook 20. The eBook 20 contains a plurality of pages P. A front edge F is displayed that forms a part of the eBook 20. In the present specification, the user operates the touch panel 220 using his/her single finger. The touch panel 220 detects the touch point of the finger in touch with the display surface of the display section 210.

As shown in FIG. 2A, when the touch panel 220 detects the touch point moving from the point D1 toward the point D3, the display control section 100 responsively flips pages P in the direction (see the arrow C1) corresponding to the travel direction of the touch point. The display control section 100 flips pages P during the time when the touch panel 220 detects user's touch with the display surface of the display section 210. When assuming that the travel direction of the touch point is reversed at the point D3, the display control section 100 flips pages P by the amount A10 of page flip that corresponds to the amount of travel of the touch point from the point D1 to the point D3 during the time when the touch point moves from the point D1 to the point D3.

As shown in FIG. 2B, when the touch panel 220 detects a reversal of the travel direction of the touch point at the point D3, the display control section 100 reverses the page flip direction (see an arrow C2) and flips the pages P. The display control section 100 flips pages P during the time when the touch panel 220 detects user's touch with the display surface of the display section 210. When assuming next that the travel direction of the touch point is reversed again at the point D5, the display control section 100 flips pages P by the amount A20 of page flip that corresponds to the amount L20 of travel of the touch point from the point D3 to the point D5 during the time when the touch point moves from the point D3 to the point D5.

As shown in FIG. 2C, when the touch panel 220 detects a reversal of the travel direction of the touch point at the point D5, the display control section 100 responsively reverses the page flip direction (see an arrow C1) and flips pages P. The display control section 100 flips the pages P during the time when the touch panel 220 detects user's touch with the display surface of the display section 210. When still assuming that the travel direction of the touch point is reversed again at the point D7, the display control section 100 flips the pages P by the amount A30 of page flip that corresponds to the amount L30 of travel of the touch point from the point D5 to the point D7 during the time when the touch point moves from the point D5 to the point D7.

[Display Control Method]

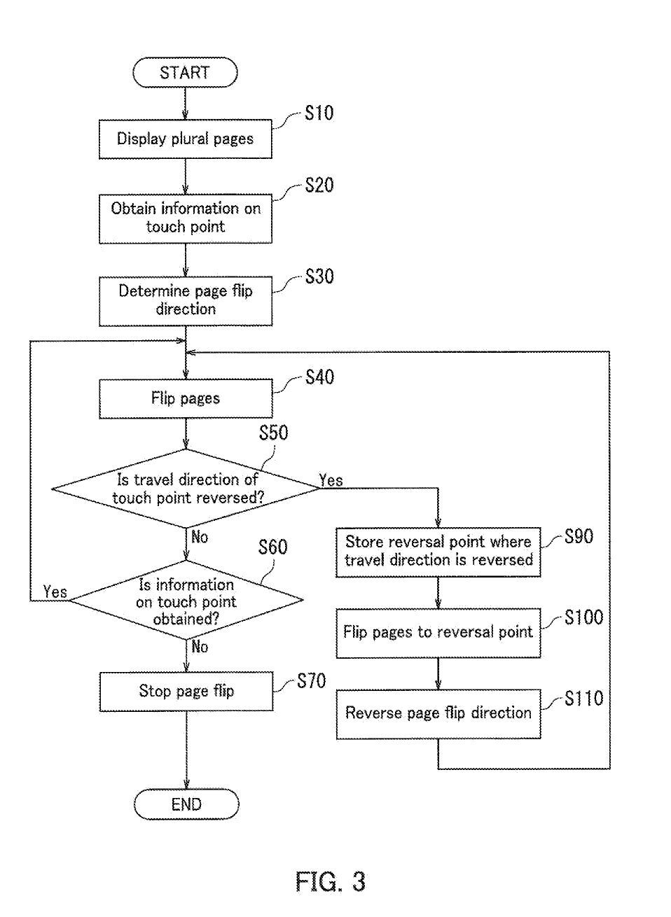

With reference to FIGS. 1-3, a display control method will be described that the display device 10 performs. FIG. 3 is a flowchart depicting the display control method. Through execution of Steps S10 to S110, the display control section 100 can change the amount of page flip each time a change in the travel direction of the touch point is detected. A specific procedure is as follows.

At Step S10, the display control section 100 causes the display section 210 to display the plurality of pages P (the eBook 20). At Step S20, the display control section 100 obtains through the touch panel 220 information on the touch point in touch with the display surface of the display section 210. At Step S30, the display control section 100 determines the page flip direction corresponding to the travel direction of the touch point. At Step S40, the display control section 100 flips the pages P.

At Step S50, the display control section 100 determines whether or not the travel direction of the touch point that the touch panel 220 detects is reversed. When a negative determination is made (No) at Step S50, the routine proceeds to Step S60. At Step S60, the display control section 100 determines whether or not the information on the touch point is obtained through the touch panel 220. When a positive determination is made (Yes) at Step S60, the routine returns to Step S40. In this manner, the display control section 100 flips pages P during the time when the touch panel 220 detects user's touch with the display surface of the display section 210.

By contrast, when a negative determination is made (No) at Step S60, the routine proceeds to Step S70. At Step S70, the display control section 100 stops the page flip.

When a positive determination is made (Yes) at Step S50, the routine proceeds to Step S90. At Step S90, the display control section 100 stores the reversal point where the travel direction of the touch point is reversed. At Step S100, the display control section 100 flips pages P up to the reversal point. At Step S110, the display control section 100 reverses the page flip direction. Then, the routine returns to Step S40.

The display control section 100 executes Steps S30, S110, and S40 to flip pages toward the last page or the top page of the pages in the direction corresponding to the travel direction of the touch point.

As has been described with reference to FIGS. 1-3, in the first embodiment, the amount of page flip can be decreased in a stepwise manner (the amounts of page flip: A10>A20>A30) each time a reversal of the travel direction of the touch point is detected. Accordingly, the page search range can be reduced, thereby enabling mitigation of a burden in page search for a target page P. Further, according to the first embodiment, pages P are flipped during the time when the touch panel 220 detects the touch point. This means that the user's continuous touch can flip pages P. As a result, fine adjustment of page flip can be facilitated. Moreover, the user can more easily and intuitionally flip pages P than in the case of page flip by pushing a button on the touch panel. Still further, a target page P can be searched with less steps.

Yet further, according to the first embodiment, the amount of page flip is independent of the number of fingers in touch, in other words, is free from limitations on the number of fingers in touch. Also, detection of a plurality of touch points is not required for page flip. This can eliminate the need of complicated circuits and processes for detection of three or more points. In addition, the relationship between the travel direction of the touch point in page flip and the direction of page flip approximates to the relationship between a direction of a finger moving in turning pages of an actual book and a direction in which pages of the book are turned. Accordingly, further intuitional page flip (turning) can be achieved.

The display control section 100 may change the amount of page flip per unit amount of travel of the touch point each time the travel direction of the touch point changes. Detailed description will be made in the following second embodiment.

### Second Embodiment

[Outline]

With reference to FIG. 1, description will be made about the display device 10 according to the second embodiment of the present disclosure. The display device 10 according to the second embodiment has the same configuration as the display device 10 shown in FIG. 1. The display control section 100 causes the display section 210 to display on an enlarged scale to-be-flipped pages P out of the pages P each time the touch panel 220 detects a change in the travel direction (a reversal in the second embodiment). Accordingly, the amount of page flip per unit amount of travel of the touch point can be decreased. As a result, page visibility and efficiency of page search for a target page P can be enhanced.

[Details of Page Flip Control]

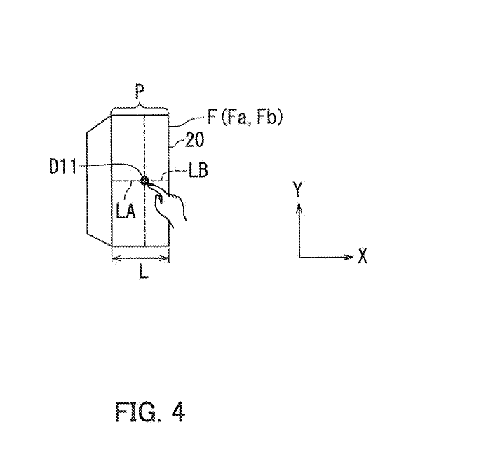

Page flip control (scale control) will be described in detail with reference to FIGS. 1, 4, and 5. The eBook 20 will be discussed as an example in the second embodiment. FIG. 4 is a diagram for explaining a display format of the eBook 20 (a plurality pages P) that the display device 10 displays initially.

As shown in FIG. 4, the display control section 100 causes the display section 210 to display the eBook 20 in an upright, closed state. The eBook 20 contains a plurality of pages P. The display control section 100 causes the display section 210 to display a front edge F that forms a part of the eBook 20. The front edge F functions as an operation region. The display control section 100 determines a page P as a page flip start point out of the pages P according to the position of the touch point (e.g., a point D11) in the front edge F. Specific procedure is as follows.

The front edge F in a state in which the eBook 20 is closed has a width L that expresses the total number N of pages of the eBook 20. The display control section 100 calculates a page P corresponding to the point D11 where the touch panel 220 detects the touch point, based on the width L and a length LA from the point D11 on the front edge F to the top page P, or the width L and a length LB from the point D11 on the front edge F to the last page P. The display control section 100 determines a page corresponding to the point D11 as a page P serving as a flip start point. The page number of the page P serving as the page flip start point can be obtained by (LA/L)×N or (1−LB/L)×N. For example, the user touches his/her finger with a point around a target page P in the front edge F as a yardstick for specification of a page P that is to be opened first (a page P serving as a page flip start point). Accordingly, the user can search for the target page P using the first opened page P as a reference. This can result in more efficient page search for the target page P.

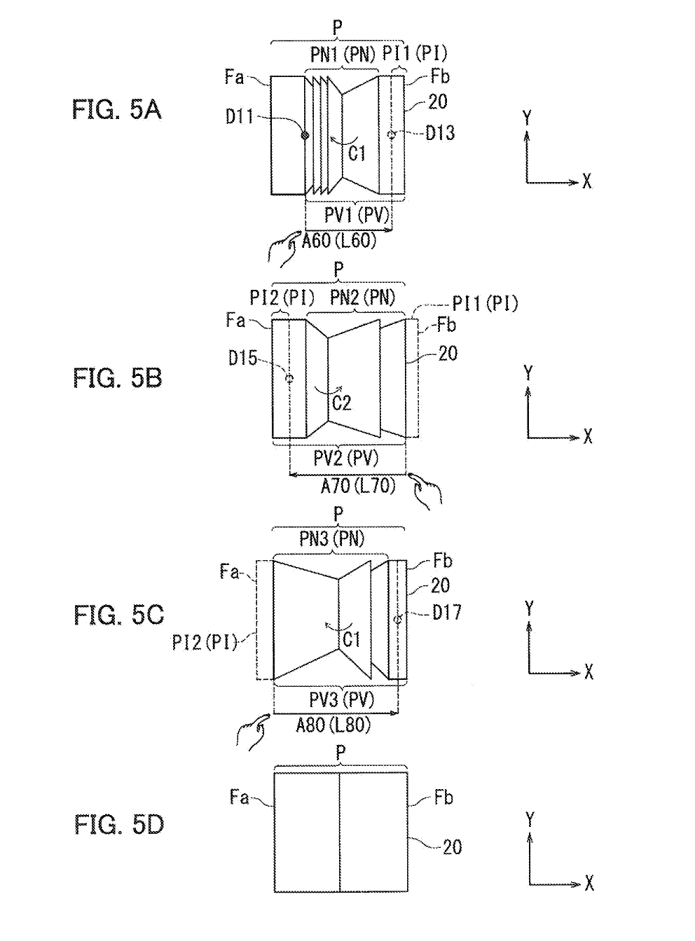

FIGS. 5A-5D are diagrams for explaining page flip control that the display device 10 performs.

As shown in FIG. 5A, when the touch panel 220 detects the touch point moving from the point D11, the display control section 100 responsively opens the eBook 20 and flips pages P in the direction (see an arrow C1) corresponding to the travel direction of the touch point. At the time when the touch point is detected at the point D11, the to-be-flipped pages P are pages PV1. When the eBook 20 is opened, the front edge F is divided. Specifically, the front edge F is divided into a front edge portion Fa and a front edge portion Fb.

Next, the user reverses the travel direction of his/her finger in touch with the display surface at the point D13.

As shown in FIG. 5B, when the touch panel 220 detects the reversal of the travel direction of the touch point at the point D13 (see FIG. 5A), the display control section 100 reverses the page flip direction (see the arrow C2) and flips pages P. In so doing, the display control section 100 causes the display section to display to-be-flipped pages PV2 at the reversal on an enlarged scale as compared with the pages PV1 before the reversal. Further, the display control section 100 hides pages PI1 (see FIG. 5A) other than the to-be-flipped pages PV2 at the reversal.

Next, the user reverses the travel direction of the finger in touch with the display surface at the point D15.

As shown in FIG. 5C, when the touch panel 220 detects the reversal of the travel direction of the touch point at the point D15, the display control section 100 responsively reverses the page flip direction (see the arrow C1) and flips pages P. In so doing, the display control section 100 causes the display section 210 to display to-be-flipped pages PV3 at the reversal (see FIG. 5B) on an enlarged scale as compared with the pages PV1 before the reversal. Further, the display control section 100 hides pages PI2 (see FIG. 5B) other than the to-be-flipped pages PV3 at the reversal.

Next, the user removes the finger in touch with the display surface at the point D17.

As shown in FIG. 5D, when the touch panel 220 detects transition from a touch point detecting state in which the touch point is detected to a touch point non-detecting state in which the touch point is not detected, the display control section 100 stops flipping pages P and changes the display format of the pages P (the eBook 20). For example, the display control section 100 changes the display format of the pages P (the eBook 20) from the upright format to a two-page spread format.

Accordingly, when the user only removes the finger from the display surface upon discovery of the target page P, the page flip can be stopped, and the target page P can be displayed in the two-page spread format. In other words, the user can change the page display format through a simple operation.

Furthermore, for example, the display control section 100 may be so set to change the page display format from the two-page spread format to the upright format (see FIG. 4) of the pages P in response to a predetermined operation (e.g., double click) that the touch panel 220 detects in the state in which the page P is displayed in the two-page spread format.

[Change in Amount Of Page Flip Per Unit Amount of Travel of Touch Point]

With reference to FIGS. 1 and 5, description will be made about change in amount of page flip per unit amount of travel of the touch point. Each time the touch panel 220 detects a change in the travel direction of the touch point, the to-be-flipped pages PV is displayed on an enlarged scale. This can decrease the amount of page flip per unit amount of travel of the touch point each time a change in the travel direction of the touch point is detected. By contrast, the amount of page flip per unit time is fixed in the second embodiment.

A specific example will be described below. Given that Mb is an amount of page flip per unit amount of travel of the touch point before a change in the travel direction of the touch point. Given also that pages P displayed after a change in the travel direction of the touch point is increased in size (zoom rate) K times pages P displayed before the change, wherein K is larger than 1. Accordingly, after a change in the travel direction of the touch point, an amount Ma of page flip per unit amount of travel of the touch point is Mb/K.

Herein, A60 and L60 in FIG. 5A denote the amount of page flip and the amount of travel of the touch point, respectively. In this case, the amount of page flip per unit amount of travel of the touch point is A60/L60, for example. Further, A70 and L70 in FIG. 5B denote the amount of page flip and the amount of travel of the touch point, respectively. In this case, the amount of page flip per unit amount of travel of the touch point is A70/L70, for example. Yet further, A80 and L80 in FIG. 5C denote the amount of page flip and the amount of travel of the touch point, respectively. In this case, the amount of page flip per unit amount of travel of the touch point is A80/L80, for example.

Each time a change in the travel direction of the touch point is detected, the amount of page flip per unit amount of travel of the touch point is decreased. Therefore, A60/L60>A70/L70>A80/L80 is derived.

[Display Control Method]

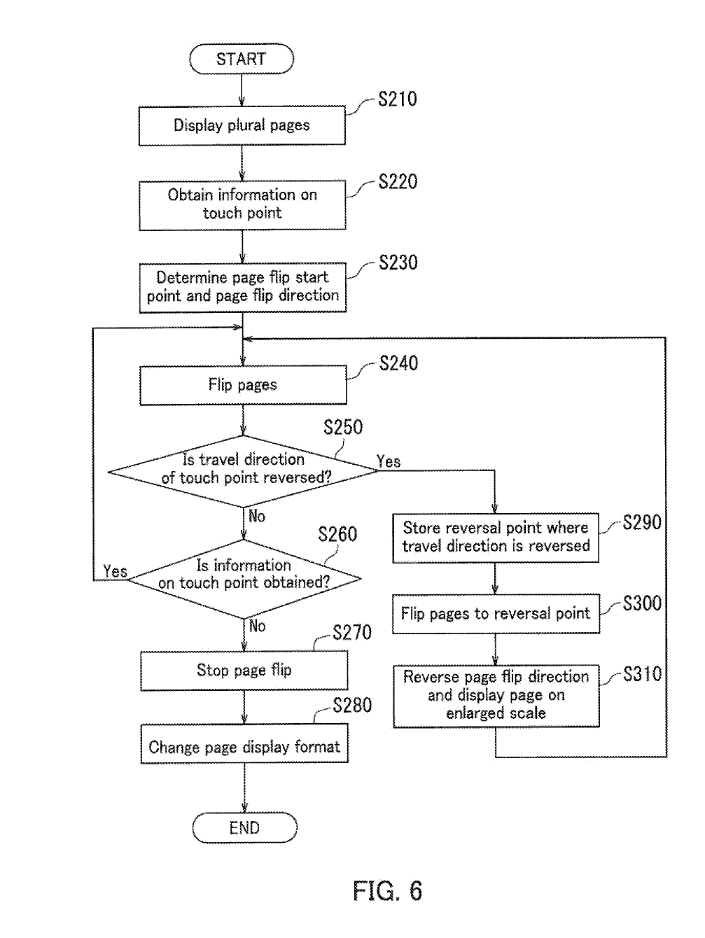

With reference to FIGS. 1, 3, and 6, a display control method will be described that the display control section 100 performs. FIG. 6 is a flowchart depicting the display control method. Steps S210, S220, S240-S270, S290, and S300 are the same in processing as Steps S10, S20, S40-S70, S90, and S100, respectively, in FIG. 3. Therefore, description of them is omitted.

At Step S230, the display control section 100 determines based on the position of the touch point the page flip start point and the page flip direction. Further, at Step S280, the display control section 100 changes the display format of the pages P (the eBook 20) to the two-page spread format. At Step S310, the display control section 100 reverses the page flip direction and displays to-be-flipped pages P on an enlarged scale. Then, the routine proceeds to Step S240.

As has been described with reference to FIGS. 1, 5, ad 6, in the second embodiment, to-be-flipped pages P is displayed on an enlarged scale (see FIGS. 5A-5C) each time the touch panel 220 detects a reversal of the travel direction of the touch point. As a result, page visibility and efficiency of page search for a target page P can be enhanced further. Furthermore, as a result of display on an enlarged scale, the amount of page flip per unit amount of travel of the touch point can be deceased. This can further enhance page visibility and efficiency of page search for a target page P . Besides, the second embodiment can achieve the same advantages as those in the first embodiment.

The display control section 100 may change the amount of page flip per unit time each time the travel direction of the touch point changes. Detailed description will be made in the following third embodiment.

### Third Embodiment

[Outline]

With reference to FIG. 1, description will be made about the display device 10 according to the third embodiment of the present disclosure. The display device 10 according to the third embodiment has the same configuration as the display device 10 shown in FIG. 1.

The display control section 100 changes the amount of page flip per unit time (hereinafter referred to as “speed”) each time the touch panel 220 detects a change (a reversal in the third embodiment) in the travel direction of the touch point. As a result, page visibility and efficiency of page search for a target page P can be enhanced.

[Details of Page Flip Control]

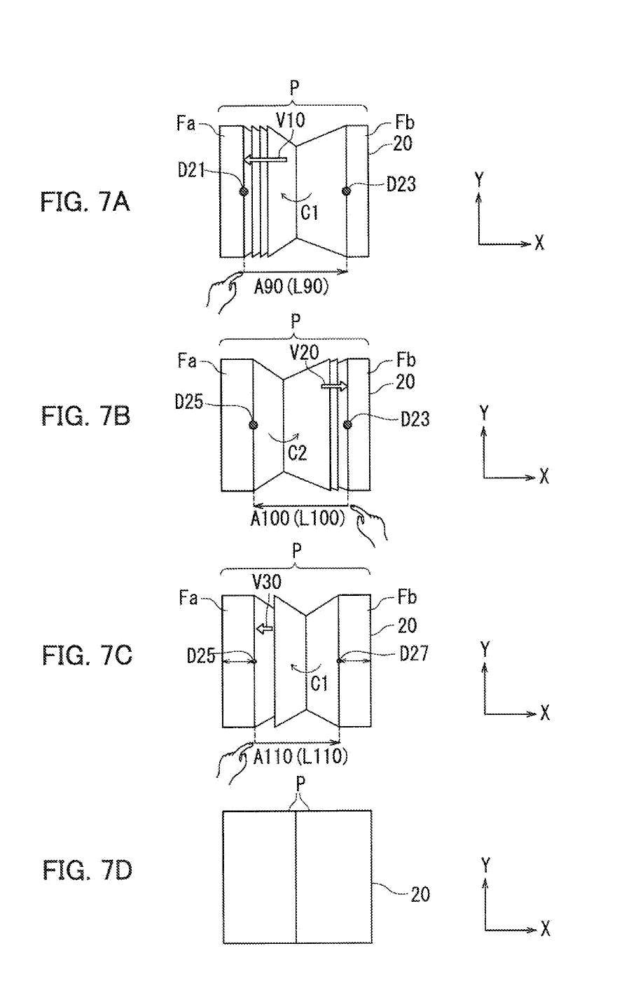

Page flip control (speed control) will be described in detail with reference to FIGS. 1, 4, and 7. The eBook 20 will be discussed as an example in the third embodiment. FIGS. 7A-7D are diagrams for explaining page flip control that the display device 10 performs.

As shown in FIG. 4, the display control section 100 causes the display section 210 to display the eBook 20 in the upright, closed state. The display control section 100 determines a page serving as a page flip start point in the pages P according to the position of the touch point (e.g., a point D11) in the front edge F of the eBook 20. The page determination scheme is the same as that in the second embodiment described with reference to FIG. 4. Therefore, description thereof is omitted.

As shown in FIG. 7A, when the touch panel 220 detects the touch point moving from the point D21 toward the point D23, the display control section 100 responsively flips pages P in the direction (see an arrow C1) corresponding to the travel direction of the touch point at a speed V10.

Next, the user reverses the travel direction of the finger in touch with the display surface at the point D23.

As shown in FIG. 7B, in response to the reversal of the travel direction of the touch point at the point D23 that the touch panel 220 detects, the display control section 100 reverses the page flip direction (see the arrow C2) and flips pages P at a speed V20. The speed V20 is smaller than the speed V10.

Next, the user reverses the travel direction of the finger in touch with the display surface at the point D25.

As shown in FIG. 7C, in response to the reversal of the travel direction of the touch point at the point D25 that the touch panel 220 detects, the display control section 100 reverses the page flip direction (see the arrow C1) and flips pages P at a speed V30. The speed V30 is smaller than the speed V20.

Next, the user removes the finger in touch with the display surface at the point D27 therefrom.

As shown in FIG. 7D, when the touch panel 220 detects transition from the touch point detecting state to the touch point non-detecting state at the point D27, the display control section 100 stops page flip and changes the display format of the pages P (the eBook 20). For example, the display control section 100 changes the display format of the pages P (the eBook 20) from the upright format to the two-page spread format.

Accordingly, when the user only removes the finger from the display surface upon discovery of the target page P, the page flip can be stopped, and the target page P can be displayed in the two-page spread format. In other words, the user can change the page display format by a simple operation.

Furthermore, for example, when the touch panel 220 detects a predetermined operation (e.g., double tap) in a state in which pages P are displayed in the two-page spread format, the display control section 100 may change the page display format from the two-page spread format to the upright format (see FIG. 4).

[Speed (Amount of Page Flip Per Unit Time)]

The display control section 100 can decrease the speed at a predetermined rate or an arbitrary rate. In the case of the decrease at the predetermined rate, for example, the decrease rate is set to 0.5 in FIGS. 7A-7C. Accordingly, the speed V20 is V10×0.5. Also, the speed V30 is V20×0.5 (=V10×0.5×0.5).

[Amount of Page Flip]

The display control section 100 determines the amount of page flip according to the amount of travel of the touch point. Given that G is an amount of page flip per unit amount of travel of the touch point. In the third embodiment, the amount G of page flip per unit amount of travel of the touch point is fixed regardless of a change in the travel direction of the touch point. Given also that L is an amount of travel of the touch point. Accordingly, an amount U of page flip is expressed by G×L.

With reference to FIGS. 7A-7C, a specific example will be described now. In FIGS. 7A-7C, the amount L of travel of the touch point is denoted by L90, L100, and L110, respectively. Accordingly, the amounts U of page flip in FIGS. 7A-7C are expressed by G×L90, G×L100, and G×L110, respectively.

[Display Control Method]

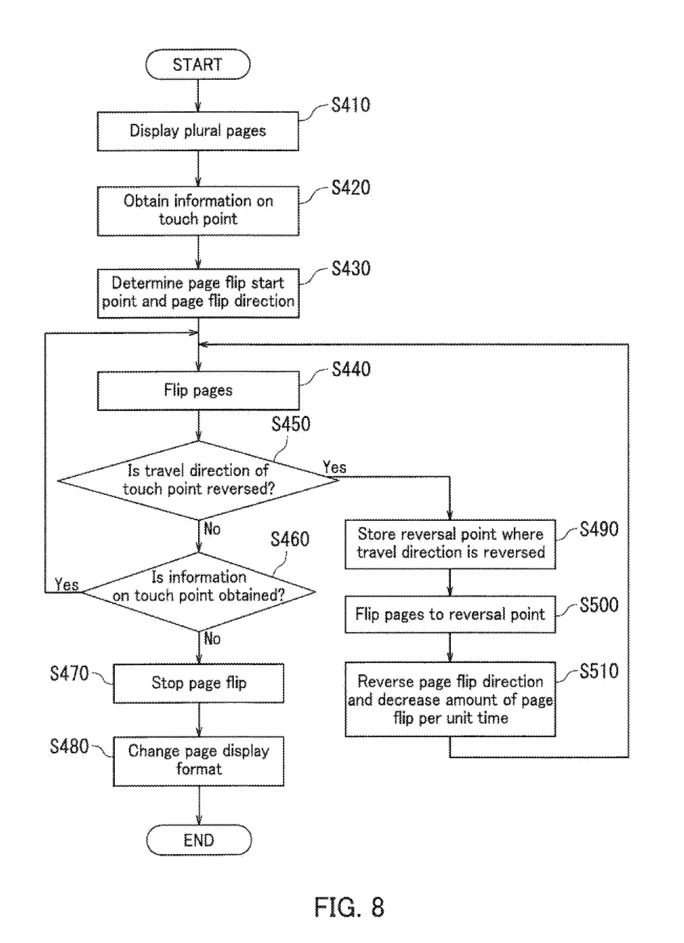

With reference to FIGS. 1, 6, and 8, a display control method will be described that the display control section 100 performs. FIG. 8 is a flowchart depicting the display control method. Steps S410-S500 are the same in processing as Steps S210-S300 in FIG. 6. Therefore, description of them is omitted. At Step S510, the display control section 100 reverses the page flip direction and decreases the amount of page flip per unit time (speed). Then, the routine returns to Step S440.

As has been described with reference to FIGS. 1, 7, and 8, in the third embodiment, the page flip speed is decreased (see FIGS. 7A-7C) each time the touch panel 220 detects a change in the travel direction of the touch point. As a result, page visibility and efficiency of page search for a target page P can be enhanced. Besides, the same advantages as those in the first embodiment can be achieved in the third embodiment.

### Fourth Embodiment

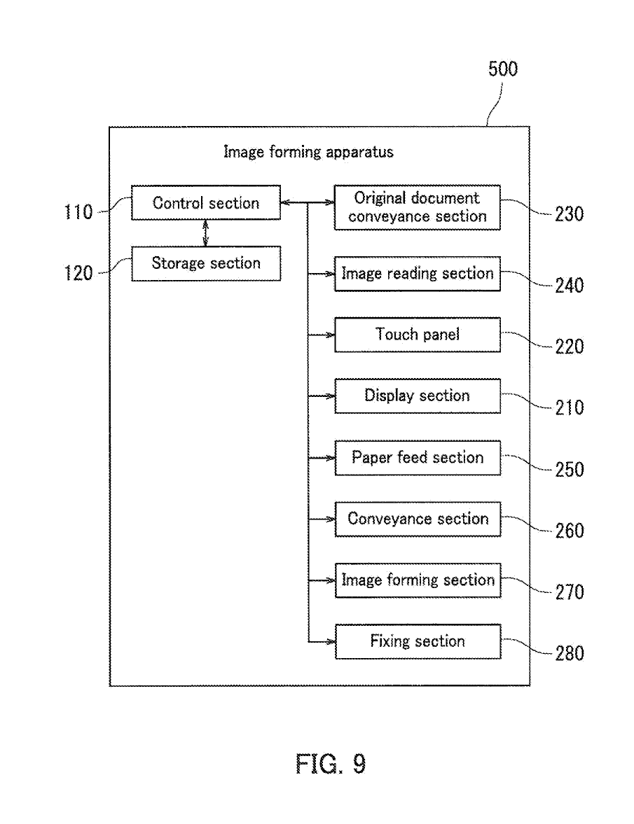

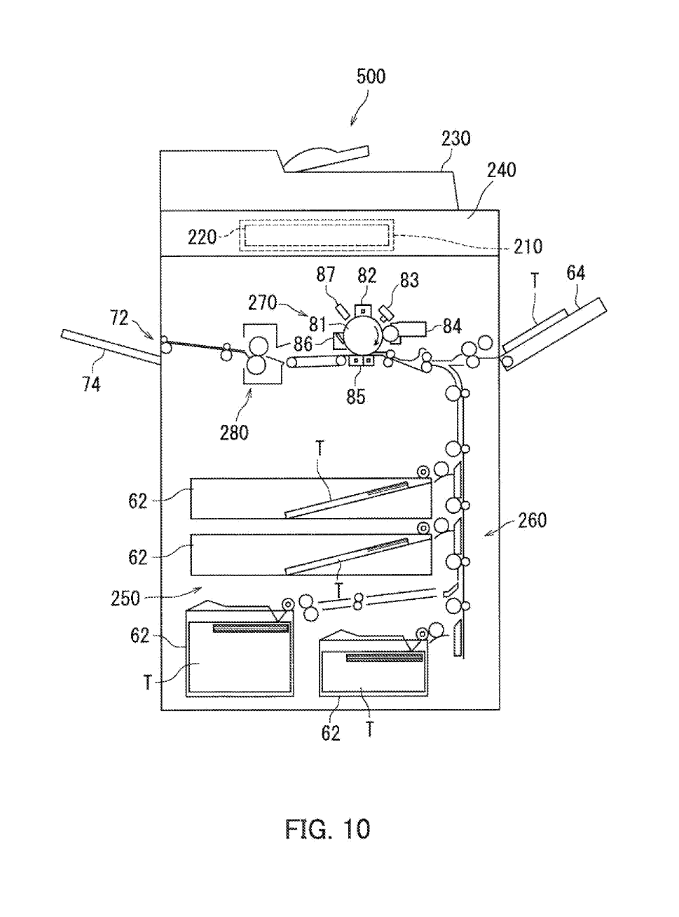

With reference to FIGS. 9 and 10, description will be made about an image forming apparatus 500 according to the fourth embodiment of the present disclosure. FIG. 9 is a block diagram showing the image forming apparatus 500. FIG. 10 is a schematic cross sectional view explaining the image forming apparatus 500.

The image forming apparatus 500 includes a control section 110, a storage section 120, an original document feed section 230, an image reading section 240, the touch panel 220, the display section 210, a paper feed section 250, a conveyance section 260, an image forming section 270, and a fixing section 280. The storage section 120 incudes a main storage device (e.g., a semiconductor memory) and an auxiliary storage device (e.g., a semiconductor memory or a hard disk drive).

The control section 110 controls the entire image forming apparatus 500. Specifically, the control section 110 executes a computer program stored in the storage section 120 to control the original document feed section 230, the image reading section 240, the touch panel 220, the display section 210, the paper feed section 250, the conveyance section 260, the image forming section 270, and the fixing section 280. The control section 110 may be a central processing unit (CPU), for example. The touch panel 220 is arranged on the display surface of the display section 210, for example.

The control section 110 also functions as the display control section 100 in the first, second, or third embodiment. Accordingly, the control section 110, the display section 210, and the touch panel 220 constitute the display device 10 of any of the first to third embodiments. The storage section 120 stores image data of a plurality of pages P (an eBook 20).

The original document feed section 230 feeds an original document to the image reading section 240. The image reading section 240 reads an image of the original document to generate image data. The paper feed section 250 includes a paper feed cassette 62 and a manual feed tray 64. Sheets T are to be loaded on the paper feed cassette 62. A sheet T is sent out from the paper feed cassette 62 or the manual feed tray 64 to the conveyance section 260. These sheets T may be plain paper, recycled paper, thin paper, thick paper, an overhead projector (OHP) sheet, or the like.

The conveyance section 260 conveys the sheet T to the image forming section 270. The image forming section 270 includes a photosensitive drum 81, a charger 82, an exposure section 83, a flip section 84, a transfer section 85, a cleaning section 86, and a static eliminating section 87. Specifically, the image forming section 270 forms (prints) the image on the sheet T as follows.

The charger 82 electrostatically charges the surface of the photosensitive drum 81. The exposure section 83 irradiates the surface of the photosensitive drum 81 with light based on the image data generated by the original document reading section 240. As a result, an electrostatic latent image corresponding to the image data is formed on the surface of the photosensitive drum 81.

The development section 84 develops the electrostatic latent image formed on the surface of the photosensitive drum 81 to form a toner image thereon. When the sheet is supplied between the photosensitive drum 81 and the transfer section 85, the transfer section 85 transfers the toner image to the sheet T.

The sheet T to which the toner image is transferred is conveyed to the fixing section 280. The fixing section 280 applies heat and pressure to the sheet T to fix the toner image to the sheet T. Then, an ejection roller pair 72 ejects the sheet T onto an exit tray 74. The cleaning section 86 removes toner remaining on the surface of the photosensitive drum 81. The static eliminating section 87 removes residual charges on the surface of the photosensitive drum 81.

It should be noted that the present disclosure is not limited to the above embodiments and practicable in various manners within the scope not departing from the gist of the present disclosure. The following variations are possible, for example.

(1) The amount of page flip per unit time (speed) is fixed, while the amount of page flip per unit amount of travel of the touch point is changed in the second embodiment discussed with reference to FIGS. 5A-5D. By contrast, the amount of page flip per unit amount of travel of the touch point time is fixed, while the amount of page flip per unit time (speed) is changed in the third embodiment discussed with reference to FIGS. 7A-7D. However, both the amount of page flip per unit time (speed) and the amount of page flip per unit amount of travel of the touch point may be changed each time the travel direction of the touch point changes. For example, in the second embodiment, each time the travel direction of the touch point changes, the to-be-flipped pages P may be displayed on an enlarged scale, and the amount of page flip per unit amount of travel of the touch point (speed) may be changed.

(2) In the second embodiment described with reference to FIGS. 5A-5D, the to-be-flipped pages PV of the pages P are displayed on an enlarged scale on the display section 210 each time the travel direction of the touch point changes. However, the to-be-enlarged target is not limited. For example, only a page PN under flip out of to-be-flipped pages PV may be displayed on an enlarged scale each time the travel direction of the touch point changes. The pages P under flip in FIGS. 5A-5C are pages PN1, PN2, and PN3, respectively. Besides, the pages PI other than the to-be-flipped pages are hidden, for example, in the second embodiment. However, the entire eBook 20 may be displayed on an enlarged scale each time the travel direction of the touch point changes.

(3) The present disclosure is applicable to fields of display devices, image forming apparatuses, and display control methods for display of a plurality of pages (e.g., an eBook or a set of images).

What is claimed is:

1. A display device comprising:
a display section having a display surface and configured to display a plurality of pages;
a detecting section configured to detect a touch point in touch with the display surface of the display section; and
a display control section configured to flip a page toward a last page or a top page of the pages in a direction corresponding to a travel direction of the touch point,
wherein the display control section changes an amount of page flip each time the detecting section detects a change in the travel direction.

2. A display device according to claim 1, wherein
the display control section displays on an enlarged scale a to-be-flipped page out of the pages on the display section each time the detecting section detects a change in the travel direction.

3. A display device according to claim 1, wherein
the display control section changes an amount of page flip per unit amount of travel of the touch point each time the detecting section detects a change in the travel direction of the touch point.

4. A display device according to claim 1, wherein
the display control section changes an amount of page flip per unit time each time the detecting section detects a change in the travel direction of the touch point.

5. A display device according to claim 1, wherein
the display control section flips a page during the time when the detecting section detects a touch with the display surface.

6. A display device according to claim 1, wherein
the display control section changes a page display format from a upright format to a two-page spread format when the detecting section detects transition from a touch point detecting state to a touch point non-detecting state.

7. A display device according to claim 1, wherein
the display control section causes the display section to display an operation region and determines a page serving as a page flip start point out of the pages according to a position of the touch point in the operation region.

8. A display device according to claim 1, wherein
each time the detecting section detects a change in the travel direction of the touch point, the display control section displays on an enlarged scale a to-be-flipped page out of the pages on the display section and changes an amount of page flip per unit amount of travel of the touch point.

9. A display device according to claim 1, wherein
when the detecting section detects transition from a touch point non-detecting state to a touch point detecting state, the display control section changes a page display format from a two-page spread format to an upright format.

10. An image forming apparatus comprising:
a display device according to claim 1; and
an image forming section configured to form on a sheet an image of a page selected from the pages.

11. A display control method comprising:
displaying a plurality of pages on a display section;
obtaining information on a touch point in touch with a display surface of the display section;
flipping a page toward a last page or a top page in a direction corresponding to a travel direction of the touch point; and
changing an amount of page flip of the pages each time a change in the travel direction of the touch point is detected.
